(19) United States
(12) Patent Application Publication
(10) Pub. No.: US 2006/0222156 A1
(43) Pub. Date: Oct. 5, 2006

(54) Secure global telephone number system and method of operation

(75) Inventors: C. Eric Smith, Austin, TX (US); R. Stacey Zuniga, Austin, TX (US)

Correspondence Address: HULSEY IP INTELLECTUAL PROPERTY LAWYERS, P.C., 1250 S. CAPITAL OF TEXAS HIGHWAY, BUILDING THREE, SUITE 160, AUSTIN, TX, 78746, US

(73) Assignee: PORTALPLAY, INC.

(21) Appl. No.: 11/098,969

(22) Filed: Apr. 5, 2005

(51) Int. Cl. H04M 3/42; H04M 3/00

(52) U.S. Cl. 379/207.14; 379/210.01; 379/245

(57) ABSTRACT

Techniques for processing calls in a communications system. A method and a system for protecting a person's telecommunications identify includes associating a global phone number with at least one contact address. The person may publicize global number. Thereafter, the person receives all communications using the global number. Using global number, the disclosed subject matter confidentially transfers the communications from global number to at least one direct contact address. The method and system may further include screening out undesirable communications.

### FIELD

This disclosed subject matter relates to the field of telecommunications and telephone systems, and more particularly to an improved system-subscriber interface and secure global telephone number system and method of operation that allows a person to more efficiently and effectively control callers seeking to reach the person.

### DESCRIPTION OF THE RELATED ART

Today, people are busy and their time is valuable. Communications is one aspect of modern life that occupies a significant portion of our waking hours. For example, it is not unusual for people to have a home phone, a work phone, a wireless handset, a fax number, and several eMail addresses. Just weeding invited and important communications from unwanted and uninvited communications can take several hours a day for some people.

Also, once a person's contact information is publicized, the available ways to control who calls and when on any given contact means are very limited. Some people object to being interrupted in the early evening hours by telemarketing calls to their home phones. Some people object to numerous calls that come in to their children at all hours of the day and night. More seriously, for some people calls from stalkers and others with evil intent can cause significant trauma and disruption.

Screening calls is common, but time consuming. Changing phone numbers and eMail addresses is possible, but inconvenient and sometimes costly. Calls may be routed to an answering or reception service, but this may be costly and such people are typically not very qualified to do a good job at properly screening someone else's calls. Unlisted numbers are common, but some telemarketing firms have computerized means for getting through to the number, and once the number gets out to undesirable callers its purpose is lost. Caller identification systems are used, but there are various ways that callers can block out or otherwise get around the identification process.

As the pace of life, information exchange, and communications accelerate, there must be available better ways for people to control who may attempt to communicate with them. This necessarily includes the ability to control whether, when, how, and using what communications modes callers may reach them.

Today, every telephone (except those that are behind PBX systems) has a phone number hard-associated with that phone line, device, or account. The basis for this comes from the fact that each phone line was once tied directly into the telecommunications physical infrastructure. This practice has been perpetuated through deep ties and associations in telecommunications industry billing and account management systems.

There have been attempts made in the recent past to disassociate these numbers from providers, through number portability, but such attempts are unsuccessful in dissolving the association of specific numbers with subscriber accounts. By and large, this hold-over of the telecommunications system still exists today in its traditional form.

Presently, it is impossible for a person to adequately filter inbound communications. Once someone has a person's telephone number, they can call from anywhere at any time. The person cannot “take back” or “undo” the knowledge of a third party once they know the person's number. The person's only options are to change phone numbers or filter all unknown inbound calls through voicemail, an answering machine, a secretary, or the like. But this strategy has limits—there's the time, effort, and cost of having to affirmatively deal with that filtering. This problem is exacerbated by the explosion of use of mobile or cellular telephones. These phones are uniquely personal devices that have the ability to “find” a person anywhere, and are extremely difficult to “filter” through traditional means.

Thus, there is no efficient, effective way of handling or managing the significant numbers of callers and reasons for calling that may occur on any given phone line, regardless of the person's interest (or disinterest) in talking to a given caller.

There is, therefore, a need for a telephone communications system that masks the person's means of direct communication, so that the person has the ability to decide what inbound communications to accept and what to reject. There is the need for a way to authorize caller to contact a person without the need for disclosing direct contact information. There is the need for an easily controllable and changeable method for contacting a person, to minimize and manage use and disruption of a person's time. There is a need for a person to be able to change publicized contact information or contact privileges quickly and easily, without having to change numbers, to minimize and manage use and disruption of a person's time.

### SUMMARY

Techniques are provided for an improved system-subscriber interface and secure global telephone number system and method of operation that allows a subscriber to more efficiently and effectively control callers seeking to reach the subscriber.

According to one aspect of the disclosed subject matter, there is provided a method and a system for protecting a person's telecommunications identify that includes associating a global phone number with at least one contact address (or aliased/proxied phone number). The person may publicize global number. Thereafter, the person receives all communications using the global number. Using global number, the disclosed subject matter confidentially routes the communications from global number to at least one direct contact address. The method and system may further include screening out undesirable communications.

Another aspect of the disclosed subject matter includes providing a central account system. The central account system includes at least one global number account. The central account system functionally associates at least one direct contact address to global number account. The system receives incoming communications to global number account through a telecommunications network. The system, furthermore, switches/routes the incoming communications through a global number account to the direct contact address. The system may also include a global number account database for storing communications attributes. In operation, the central account system functionally associates the direct contact address to the global number account. The system receives incoming communications to the global number account through a telecommunications network and switches incoming communications through the global number account to the direct contact address through the telecommunications network. The system provides a global number account database for storing subscriber-defined communications attributes and processing of communications to enhance subscriber privacy and communications prioritization.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages be included within this description, be within the scope of the accompanying claims.

### BRIEF DESCRIPTIONS OF THE DRAWINGS

The features, nature, and advantages of the disclosed subject matter will become more apparent from the detailed description set forth below when taken in conjunction with the drawings in which like reference characters identify correspondingly throughout and wherein:

FIG. 1 is a simplified block diagram of a communications system that can implement the present embodiment;

FIG. 2 depicts the secure call processing operations of one embodiment of the disclosed subject matter;

FIG. 3 provides a block diagram of the top level call operations of one embodiment of the disclosed subject matter; and

FIGS. 4 and 5 illustrate the account processing for one aspect of the disclosed subject matter.

### DETAILED DESCRIPTION OF THE SPECIFIC EMBODIMENTS

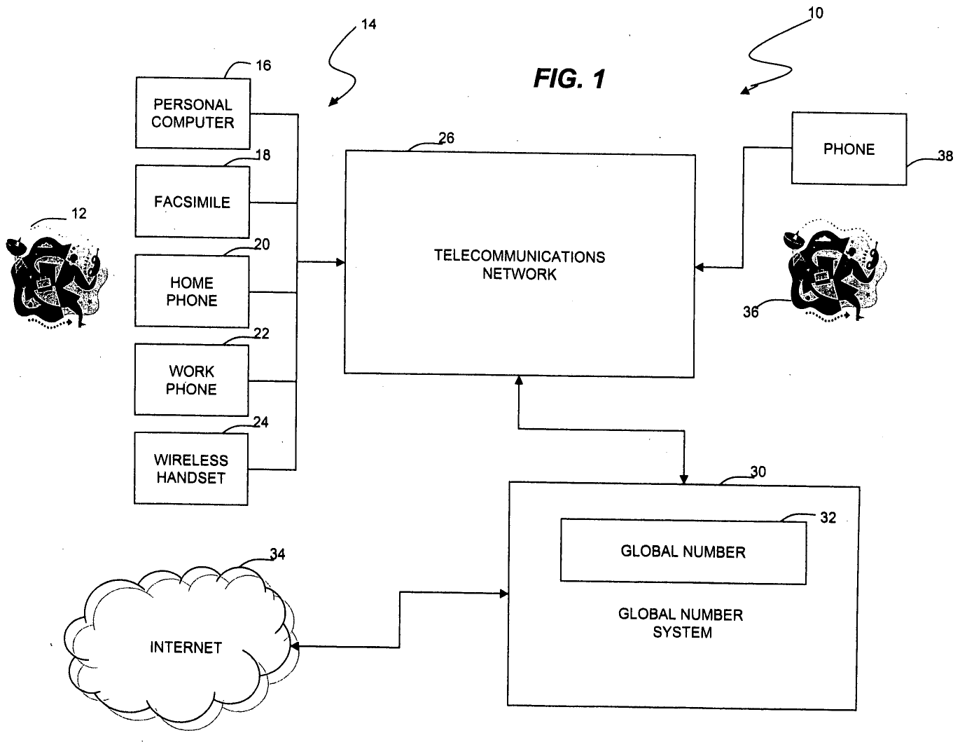

FIG. 1 depicts telecommunications environment 10 for practicing the teachings and novel concepts of the disclosed subject matter. In particular, in telecommunications environment 10 includes subscriber 12, who may use a variety of telecommunications devices 14. Such devices may include personal computer 16, facsimile machine 18, home telephone 20, work telephone 22, and wireless handset 24, for example. Telecommunications devices 14 interface telecommunications network 26.

The disclosed subject matter includes a global number system 30, which provides subscriber 12 with a global number 32 and makes use of the Internet or other on-line communications network 34 for providing the security, privacy, portability, and other features and benefits herein described. In one embodiment of the disclosed subject matter, global number system 30 and global number 32 may be marketed and sold under the trademark or service mark “gNumber™.” However, there may be many other names or marks under which global number system 30 and/or global number 32 may be offered for sale or otherwise appear commercially. Global number 32 has the form and number of digits of a telephone number appropriate to the locale, region, or country of the subscriber's choosing, which may include toll-free numbers. In addition to subscriber 12 connecting to global number system 30, caller 36 may use any number of telecommunications devices or phones 38 for interfacing telecommunications network 26 in contacting subscriber 12. It is global number system 30 that controls the various ways in which caller 36 may communicate with subscriber 12.

The present embodiment of the disclosed subject matter includes, therefore, global number system, which includes a global number website, a global number that operates in association with telecommunications devices 14, and wide variety of functions and capabilities associated therewith. Subscriber 12 obtains the benefit of the present embodiment by signing up for global number system 30.

In order to sign up for the system, subscriber 12 accesses a global number system 30 website. At the website, subscriber 12 creates an account profile. The account profile includes contact, billing, personal, and preference data for subscriber 12. Upon establishing a subscriber account, subscriber 12 receives a global number. The global number may be allocated to subscriber 12 from a pool of potential numbers provided by a Voice over IP (VoIP) systems provider. This approach differs, therefore, from other approaches which bind the phone number to a particular device, such as a voice over IP terminal device, such as that provided by Vonage® or ATT®, or a GSM card in a wireless handset, or the like which binds the number in a 1-1 association with a particular electronic device.

The present embodiment, therefore, provides a disassociation of the phone number, here global number 32, with any telecommunications device 14. Global number system 30 provides a logical process made available to subscriber 12, upon subscriber 12 establishing a global number 32 account. In the account set up, global number 32 serves as a proxy for the purpose of establishing alternative communication channels for subscriber 12. The various alternative communication channels are phone numbers that associate with global number 32 serving as a proxy for the various channels, all controlled by subscriber's global number account.

For many subscribers 12, such information may in added to a subscriber's account profile only once, with updates as may be somewhat infrequently required. A business traveler, on the other hand, may make more frequent updates to a subscriber account profile in order to use the global number 32 in allowing others to reach the business traveler across the globe. Examples of more frequently used information may include a hotel direct access phone number, a temporary office direct dial phone, or other temporary and direct phone numbers to reach the user.

Moreover, a business traveler may purchase, for example, a pre-paid SIM card for wireless handset access. Upon receiving the pre-paid SIM card, subscriber 12 may access the global number system 30 website to update the account profile. Thereafter, use of global number 32 will direct a call to subscriber's pre-paid SIM card number. The result, in all of these scenarios is a seamless mode of communication to subscriber 12 based on global number 32.

A key aspect of the present embodiment is that any person to whom subscriber 12 may provide global number 32 never has knowledge of numbers for the various alternative communication channels with which global number 32 associates. With a set of rules and options associated with global number 32 and subscriber 12 account, an interaction with multiple databases and utilities occurs. Such databases and utilities may include a contact database, such as that of the Outlook® contact database or a database of possible state information which would provide to caller 36 information concerning the state of subscriber 12 (e.g., “Busy,” “Away,” “In a Meeting,” etc.). In addition, caller 36 may be directed to a presence detection utility that may dynamically evaluate the state of subscriber 12 to provide real-time information concerning whether, for example, subscriber 12 is “In A Meeting,” or otherwise unavailable, without subscriber 12 having to specifically provide such information in a database of other utility. Such a utility may, for example, set a plurality of flags for prioritizing call routing or perform other similar functions. Other similar or related information and functions may exist in such databases, series of databases, or applications for the purpose of benefiting both caller 36 and subscriber 12.

Thus, subscriber 12 sets up global number 32 account, receives global number 32, and performs the various communications channel and contact information updates and other functions needed to establish global number system 30 operations. With these actions taken, subscriber 12 may provide global number 32 on a business card, eMail signature, letterhead, or other type of correspondence, communication, advertisement, or other publication that provides to global number 32 selected individuals, groups of individuals, or the public in general. In essence, global number 32 becomes subscriber's public telecommunications address for all telecommunications functions subscriber 12 may desire to provide to anyone.

The present embodiment makes use of both a contact database and a customer database. The customer database may, for example, include such information as call routing number, account preferences, set up information, global preferences, presence information and other subscriber-specific information. The contact database, on the other hand, includes information about contacts with which the present embodiment makes the calls here described and through the use of which the present embodiment provides various controls and protections. In some respects, therefore, the information contained in the customer database may more closely resemble information contained in a subscriber's Outlook® contact database.

One particularly attractive feature of the disclosed subject matter includes the ability to vary a caller's access to subscriber 12 according to the various selections subscriber 12 may make on the global number system 30 website. For example, according to particular levels of trust that may exist between subscriber 12 and any potential caller 36, subscriber 12 may control various groupings and permissions behaviors that may relate to different contacts.

In further particularity, for known callers the present embodiment permits establishing a practically infinite number of subscriber-defined groups. Such groups may be, for example, “Friends,” “Family,” “Business Associates,” “Athletic Team Members,” and the like. Using global number 32 website, subscriber 12 may select and establish various types of access behavior for the groups. For example, for the “Friends” group, subscriber 12 may establish that “IN GENERAL . . . FRIENDS . . . MAY CONTACT ME . . . ON MY MOBILE . . . AFTER 3 P.M . . . . ON WEEKDAYS.”

In addition, an even more specialized level of access may be provided to certain callers. That is, continuing with the example, suppose that subscriber 12 will host a social gathering in the next week. In such a case, subscriber 12 may program global system 30 so that “DURING THE PERIOD Mar. 30, 2005 THROUGH Apr. 4, 2005 . . . FRIENDS MAY CONTACT ME . . . ON ANY PHONE . . . AT ANY TIME . . . ON ALL DAYS.” This may be accomplished by setting functions and criteria for individual callers 36 who may be in a group, or by setting functions and criteria at the group (e.g., FRIENDS) level. Such selections may be made dynamically and, for example, using various menus and other tools to facilitate both standardization of subscriber 12 selections, as well as making subscriber 12 readily aware of the many functional options available through use of global number 32.

Thus, for a given known caller 36 or a group or groups of known callers, global number system 30 allows subscriber 12 to set functions and criteria that determine how such known callers may access subscriber 12 via use of global number 32. Such individuals may be identified via an Outlook® or other contact database file, directly typed into global number 32 website, extracted from various web pages, or otherwise included within the database of the global number system 30 website. The present embodiment involves subscriber 12 account being established, the subscriber's global number assigned, contacts included in a global number system 30 contact database. Subscriber 12 may print global number 32 on the subscriber's business card and otherwise publish global number 32. Then, global number system 32 uses various filters for functions and criteria assigned to such contacts via global number system 30, subscriber 12 now controls how such contacts may make calls or otherwise conduct communications operations with subscriber 12.

Global number system 30 provides the ability to apply individual specific subscriber 12 preferences. For example, subscriber 12 may designate that calls are not to be routed through from a particularly undesirable caller. In such case, subscriber 12 may direct that a call from an unapproved contact, for example, connect to a particular recording or otherwise indicate to such caller 36 that subscriber 12 desires not to communicate with caller 36.

At even a more granular level, the present embodiment may permit subscriber 12, for example, to record a single, specific message (e.g., a specific .wav file), for a individual caller. Such a message may say, for example,
“JONATHAN, I AM RECEIVING THIS CALL THROUGH MY G-NUMBER SYSTEM. AS WE DISCUSSED LAST WEEK, PLEASE PICK ME UP AT THE AIRPORT ON MARCH 31, 2005 AT 6:20 P.M.”.

When such caller 36 (here, Jonathan) calls subscriber 12, global number system 30 will connect caller 36 to the specific message. No other caller will receive such a message. In response to receiving such a message, caller 36 (here Jonathan) may be permitted to respond in many different ways. For example, caller 36 may be allowed to leave a recorded message, directed to subscriber 12, or allowed to call another person; all with the cooperation of subscriber 12 through global number system 30.

As can be seen through this example and its novel aspects, the present embodiment provides an improved telecommunications platform for highly personalized and more valuable telecommunications operations. The present embodiment also provides a highly valuable set of features and functions for handling calls from unknown callers. Thus, when an unknown caller 36 calls global number 32, global number system 30 will not automatically find the inbound ANI/Caller ID information associated with the unknown caller 36. That is, upon receiving the call, global number system 30 will compare the inbound ANI/Caller ID to global number 32 contact database.

At this point, caller 36 may be required to insert a PIN (Personal Identification Number) number or may be automatically passed through a logic filter to reach subscriber 12 based on the ANI/Caller ID or other authentication information. If caller 36 cannot provide the required PIN or is otherwise automatically passed through to subscriber 12, then global number system 30 identifies caller 36 as an unknown caller.

The new unknown caller 36 then receives a recording from global number system 30. The recording operates as part of an answering system with a recording such as,
“THANK YOU FOR CALLING, I AM SORRY THAT I CANNOT COME TO THE PHONE NOW. YOU HAVE REACHED ME VIA MY GLOBAL NUMBER SYSTEM. PLEASE LEAVE ME YOUR CONTACT INFORMATION AND THE NATURE OF THE BUSINESS OR THE MATTER ABOUT WHICH YOU ARE CALLING, SO THAT I MAY RETURN YOUR CALL AT MY EARLIEST OPPORTUNITY. ALSO, AFTER LEAVING YOUR INFORMATION, PLEASE SELECT A PERSONAL, FOUR-DIGIT, PIN TO FACILITATE OUR FUTURE COMMUNICATIONS. ALSO, YOU MAY PROVIDE A NUMBER AT WHICH I CAN RETURN YOUR CALL.”

Then, caller 36 may leave the information for subscriber 12 followed by a PIN number (e.g., “0000”) of caller's choosing. The global number system 30, in response to receiving this information from caller 36, sends a message to subscriber 12 to notify subscriber 12 of the call from caller 36 who is not in the global number system 30 contact database. The notification to subscriber 12 may be via an SMS message, an eMail message, a recorded call to subscriber's wireless handset, voicemail notification to different phone numbers listed on subscriber's global number account, or other practical and useful means for informing subscriber 12 of the call from the unknown caller.

One embodiment of the disclosed subject matter may automatically identify unknown caller 36 on a per account basis. Such an embodiment may then direct caller 36 into an automated answering system that allows subscriber 12 to classify the unknown caller 36 after caller 36 has left a message with his name and the nature of the call (i.e., this may be a firs or initial call message). Subsequent calls will be auto-routed according to subscriber 12 control. This process, which may provide a first level of security, supplements the higher security full caller/contact registration. Additionally, high-security options for registration/PIN identification may be applied on a per-contact basis, as subscriber 12 desires.

Once subscriber 12 receives the notification from global number system 30 of the call from the unknown caller 36 and provides to subscriber 12 a highly efficient way to return the call. For instance, global number system 30, immediately after caller 36 hangs up, makes one of the above-listed calls/notifications to subscriber 12.

Subscriber 12, who may be queried for a PIN or other access authorization to the call, receives specific information about the call along with a number of options. Such options may be, for example, the ability to (1) insert caller's information into the global number system 30 contact database; and (2) make various assignments of caller 36 to one or more groups together with the ability for caller 36 to automatically satisfy the various functions and criteria associated with such groups, including, for example, assigning the appropriate priority level for future calls from caller 36. The present embodiment, therefore, provides to subscriber 12 the ability to make real-time DTMF-activated and/or voice-activated responses to various voice prompts for controlling future calls from the now-known caller. This may be controlled using the global number system 30 website. Moreover, once subscriber 12 has access to the global number system 30 website, other types of functions and criteria may be added, removed, or modified regarding the specific caller.

In the same notification call from global number system 30, subscriber 12 receives the opportunity to immediately return the call from the now-known caller. If subscriber 12 selects or commands that global number system 30 call back caller 36, then global number system 30 attempts to connect subscriber 12 to the now-known caller 36 at the number associated with the ANI/Caller ID or other number, if provided by caller 36. In so doing, global number system 30 inserts into the proxy global number ANI Server Subscriber 12. As a result, caller 36 perceives the call returning from the phone that caller 36 called, when, in fact, subscriber 12 is calling from another phone. The global number system 30, therefore, identifies the call to be coming from global number 32, instead of the phone from which subscriber 12 is calling. The phone number from which subscriber 12 calls is not made apparent to the now-known caller 36 or any other called person with the use of global number system 30.

Global number system 30, therefore, provides a way to “mask” the phone number from which a call is being made by subscriber 12. This is true; whether or not subscriber 12 calls from a phone number listed on subscriber's global number account or another number not so listed. The present embodiment, therefore, provides a the call. In such a case, in accessing global number system 30, subscriber 12 dials his own global number 32 or other access number. Upon dialing global number 32, global number system 30 answers the call with knowledge that the calling number is the same ANI/Caller ID for global number 32. Otherwise, global number system 30 requires subscriber 12 to authenticate, in the case of an access number, or if calling credentials cannot be used. The global number system 30 then provides subscriber 12 with access to a menu-driven system. The menu-driven system, then, may either permit subscriber 12 to direct dial the call recipient or navigate through the contact database using one of a variety of ways to access and use the call recipient's phone number. In either case, the call recipient will receive the ANI/Caller ID for subscriber's global number.

A third process by which global number system 30 may cause the ANI/Caller ID to display global number 32 to the call recipient involves subscriber 12 storing contact information in a wireless handset or multi-functional desktop phone in a particular way. In such a handset or phone system, subscriber 12 may store contact information such that upon directing the handset or phone to call a contact, the handset or phone takes the following action. Upon subscriber 12 selecting a particular contact, the handset or phone may (1) call subscriber's global number; (2) delay for predetermined period [e.g., using a “pause” function]; and (3) call the call recipient's direct dial phone number. This information may be entered into the call recipient's database entry for use as the call variety of ways to mask the number from which subscriber 12 may call or return a call.

The present embodiment provides, therefore, a service layer on all telecommunications services that does not rely on the functioning of the associated telecommunications systems. This permits rapid adoption and use of global number system 30 by individuals and organizations of many types. Moreover, the present embodiment may be used without any intervention by telecommunications companies.

The present embodiment, due to providing an overlay for the existing telecommunications services, enables three ways for global number 32 to appear to a call recipient as the ANI/Caller ID. These processes are described generally here and in more detail below. The first process involves using a contacts control panel or graphical user interface. In such case, subscriber 12 may select caller 36, at which point global number system 30 calls subscriber 12 and the call recipient. In this manner of bridging a call between subscriber 12 and call recipient, subscriber's ANI/Caller ID will be global number 32. This process is available in the case of subscriber 12 having an active Internet connection while making the call. Such connection may not always be available to subscriber 12. Accordingly, the present embodiment provides other ways for subscriber 12 to call a call recipient.

A second process by which the present embodiment may cause the subscriber 12 ANI/Caller ID to appear as the subscriber 12 global number 32 includes subscriber 12 calling global number system 30 to complete recipient's phone number. In this way, the call recipient will receive as the ANI/Caller ID the subscriber's global number.

This third process of using both global number 32 and the call recipient's information may occur either manually or automatically upon the call recipient's contact information being entered into global number system 30 contact database, for example. Thereafter the process of using the call recipient's name, for example, as the activation point for making a call will make this third process seamless to subscriber 12.

Finally, in the event of subscriber 12 calling a contact or call recipient who also uses global number system 30, then the present embodiment may automatically identify the calling number as another global number 32. Global number system 30 will, in response to receiving global number 32 call, simply display to the call recipient the subscriber's global number, and vice-versa. This feature, therefore, provides an added advantage of more individuals using global number system 30. This process will occur when the phone number from which subscriber 12 calls is listed by global number system 30 as a number to be proxied as a global number.

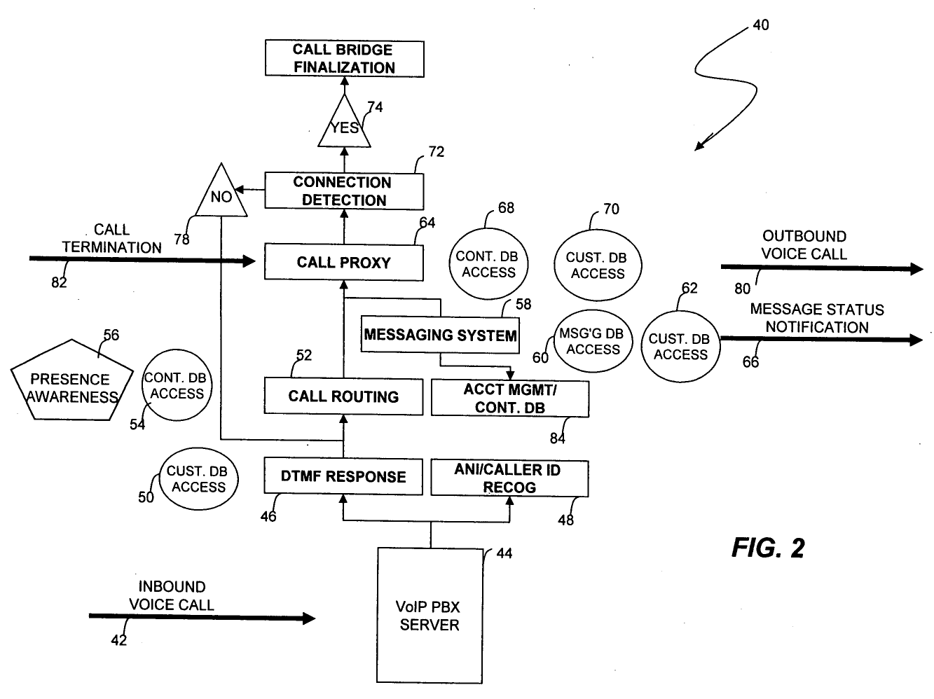

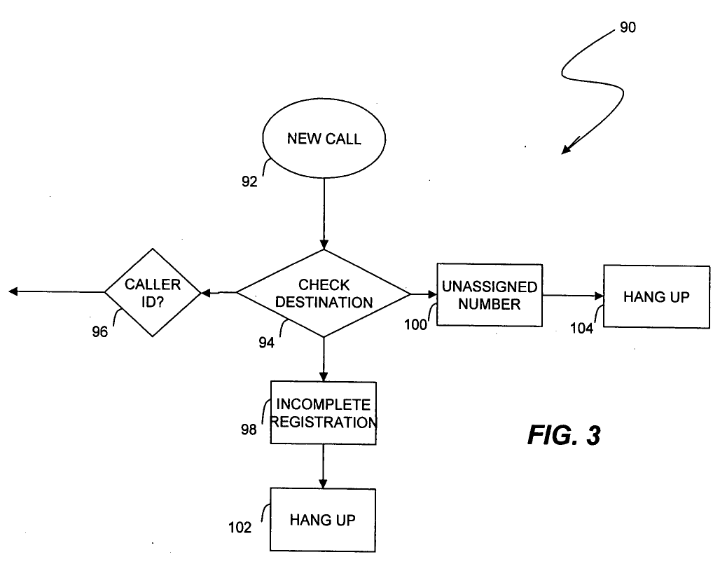

Having explained the general operation of global number system 30, FIG. 2 provides a somewhat more detailed operational description of the overall global number system 30 operational process, according to one embodiment. However, for a more detailed understanding of the logic and call flow of one of a number of possible embodiments of the disclosed subject matter, reference may also be made to FIGS. 3 through 5, below. Referring presently, however, to FIG. 2, global number system 30 performs operational process 40, which begins with inbound voice call 42 going to subscriber's global number. Inbound voice call 42 may occur once subscriber 12 has established a global number account and has provided to caller 36 subscriber's global number. Assuming that the call recipient is listed in subscriber's global number contact database, inbound call 72 proceeds to VoIP PBX server process 74. VoIP PBX server process 74 may operate a PBX software application to perform as a central or distributed server that is accessible on the Internet or some other on-line network. VoIP PBX server process 44 receives information from inbound call 42 and, in response thereto, either performs DTMF response process 46 or ANI/Caller ID recognition process 48.

In DTMF response process 46, caller 36 may enter a PIN code to log into global number system 30. Subscriber 12 may control global number system 30 to require either a PIN-based, DTMF response based process 46 or allow access using ANI/Caller ID recognition process 48. Both DTMF response process 46 and ANI/Caller ID recognition process 48 make use of contact information, functions, and criteria that subscriber 12 establishes in customer database access step 50. Thus, DTMF response process 46 may compare the PIN access data that caller 36 provides against such information for the particular caller 36 in customer database access step 50. Alternatively, for example, ANI/Caller ID recognition process 48 may compare ANI/Caller ID data associating with caller 36 to the caller's identity as stored in the information obtained through customer database access step 50. As described, above, there may be other equally effective ways for global number system 30 to perform a desired level of caller 36 authentication.

From either DTMF response process 46 or ANI/Caller ID recognition process 48, call flow continues to call routing process 52. Call routing process 52 interacts with contact database information through contact database access step 54 and, potentially, with presence awareness process 56. Presence awareness process 56, for example, may provide subscriber 12 with the ability to respond to call routing process 52 to indicate that subscriber 12 is in a meeting. Also, in the event that subscriber 12 is operating a desktop computer application, presence awareness process 56 may be programmed to indicate that subscriber 12 is not presently available. This is possible with such an application, even without subscriber 12 explicitly providing such information.

Call routing process 52 performs call routing according to the rules, functions, and criteria relating to caller 36, who has been identified and authenticated by either DTMF response process 46 or ANI/Caller ID process 48. That is, call routing process 52 controls call routing in accordance with the selections subscriber 12 makes either at the global number system 30 website using various menus and other features there provided or by voice or DTMF commands in response to a particular earlier-received call. Based on such subscriber-specified routing preferences, call routing process 52 may direct call flow to messaging system 58. Messaging system 58 may, in response, perform messaging database access step 60 to obtain a message to provide to caller 36. Such messaging database access step 60 may, according to subscriber 12 preferences, perform contact database access 62 to retrieve, for example, a contact-specific or group-specific message.

Thus, once call flow reaches call routing process 52, according to the routing rules, global number system 30 may determine that caller 36 is not an individual having authority to contact subscriber 12 either at all or at the particular time of the call. In response, call flow proceeds to messaging system 58, as stated above. With call flow at messaging system 58, global number system 30 obtains data from the call, such as an ANI/Caller ID or contact information, and performs messaging functions. In addition, global number system 30 performs customer database access step 62 to determine what notification preferences may be set for the particular caller 36, caller group, or message. Depending on recorded notification preferences, global number system 30 may notify subscriber 12, at step 96.

Call routing process 52 accommodates the many channels or ways in which global number system 30 may contact subscriber 12, all according to subscriber's selections. In fact, call routing process 52 may employ various sub-processes by which the many communication channels may seek to contact subscriber 12. For example, one sub-process may be to use all communications channels simultaneously. Another may be to perform a “round robin” or other cyclical calling technique. Alternatively, subscriber 12 may program call routing process 52 so that a sub-process including certain a certain channel hierarchy may be sought. Also, a presence-aware prioritization process or the like may be pursued by call routing process 52 for the purpose of notifying subscriber 12 of the call.

Once call routing process 52 selects the number or numbers to call in contacting subscriber 12, call flow goes to call proxy process 64. Call proxy process 64 performs contact database access step 68 and customer database access step 70 for providing to global number system 30 certain contact database and customer database information. Such information may be of relevance for logging or recording that the call was received. Such information may be, for example, the identity of caller 36, the number that caller 36 called, and the date on which caller 36 called subscriber 12. The logging information provides to subscriber 12 such information as may be needed and beneficial for subscriber 12 to respond appropriately to caller 36. For example, by knowing who called, when the call occurred, and from where the call came, subscriber 12 may make a well-reasoned response to caller 36.

Moreover, call proxy process 64 will record such calling information irrespective of whether the particular call was successful. That is, although caller 36 cannot know the communications channels on which global number system 30 sought to contact subscriber 12, such information may be presented to subscriber 12. This recording aspect of call proxy process 64 may even record calls to subscriber's wireless handset, regardless of whether subscriber 12 is inside the network calling area, thereby providing a superior call recording or logging process over that of known wireless handset networks. That is, in most wireless telecommunications networks, if subscriber 12 is out of network, then the network cannot report that a call was attempted unsuccessfully global number system 30, however, may readily provide this and related functions and features.

From call proxy process 64, call flow proceeds to connection detection process 72. Connection detection process 72 is based on line condition (e.g., long ring condition or other line signaling information) and provides to global number system 30 information indicating whether an individual or another device or connection point received the call. In the event that an individual receives the call, call flow proceeds past “YES” determination 74 to call bridge finalization process 76. Otherwise, call flow proceeds to “NO” determination 78 and back to call routing process 52. Upon reaching call bridge finalization process 76, call flow directs the call as an outbound voice call, at step 80. That is, at step 80, the inbound call and outbound call are connected together and logically disassociated from global number system 30. As such the inbound and outbound calls may be transferred to a different VoIP server, a conference server, or other threaded process on VoIP PBX server 44, which process may more directly and more simply service or maintain the calls.

In the event that connection detection process 72 determines a long ring condition, indicating that an individual has not answered the call, and based on subscriber's preferences, global number system 30 may direct call flow to subscriber's wireless handset voicemail, or other location. In fact, subscriber 12 may program global number system 30 so that caller 36 receives yet another option to select another phone for contacting subscriber 12. Global number system 30, therefore, may provide to caller 36 a variety of locations at which caller 36 may attempt to contact subscriber 12. Such an option may be explicit to caller 34, providing a selectable menu by which caller 36, according to the permissions that subscriber 12 has previously established, may choose a particular communications path (e.g., wireless handset, home phone, eMail text message, or other messaging or communications channel). Alternatively, the various locations may be automatically and transparently tried in a prioritized sequence for the purpose of connecting with subscriber 12. These features and functions are all selectable and controllable by subscriber 12 using global number system 30 website menus or phone-based controls.

At some point, the call between caller 36 and subscriber 12 will terminate. Then, notification 82 goes to call proxy process 64. Alternatively, when neither DTMF response process 46 nor ANI/Caller ID recognition process 48 authenticates caller 36, call flow proceeds to messaging system process 58 for playing back to caller 36 the appropriate recorded message and, as appropriate, recording information from caller 36. Still further, in the event that caller 36 is subscriber 12, call flow proceeds directly to account management and contact database process 54. This occurs normally when subscriber 12 returns a call or otherwise makes use of global number system 30. Once call flow is at account management/contact database process 84, subscriber 12 may determine caller 36 to call. In such event, call flow proceeds to call routing process 52 for performing the call connection steps here described.

For the processing logic of one embodiment, reference is now made to incoming call direction diagram 90 of FIG. 3. In diagram 90, when a new call 92 comes in, global number system 30 identifies, at step 94, the nature of new call 92. New call 92 may come from an active phone number, resulting in new call 92 flowing to ANI/Caller ID query 96. New call 92 may associate with an incomplete registration, causing new call 92 to flow to incomplete registration signaling step 98. Alternatively, new call 92 may be unassigned, causing new call 92 to indicate to caller 36 at step 100 that global number system 30 has not yet assigned.

If the ANI/Caller ID has not yet been assigned, global number system 30 may invite caller 36 to become a global number system 30 subscriber using such number. After global number system 30 informs caller 36 that either the ANI/Caller ID has not yet been completely registered at step 98 or that the ANI/Caller ID has not yet been assigned at step 100, global number system 30 hangs up the call, at step 102 and 104, respectively. A phone number may not be completely registered, for example, if the caller has agreed to be a subscriber, but has not yet verified the caller's phone number.

When global number system 30 receives a new call, the call to one of VoIP servers 44. Once the VoIP server 44 receives the call, VoIP server 44 determines the number that as been called, the ANI/Caller ID associated with the call, and other relevant data that may associate with the call. This calls for information through a customer database access step 50. VoIP server 44, therefore, answers all inbound calls 42 to determine whether ANI/Caller ID associates with an active or inactive subscriber 12 phone number.

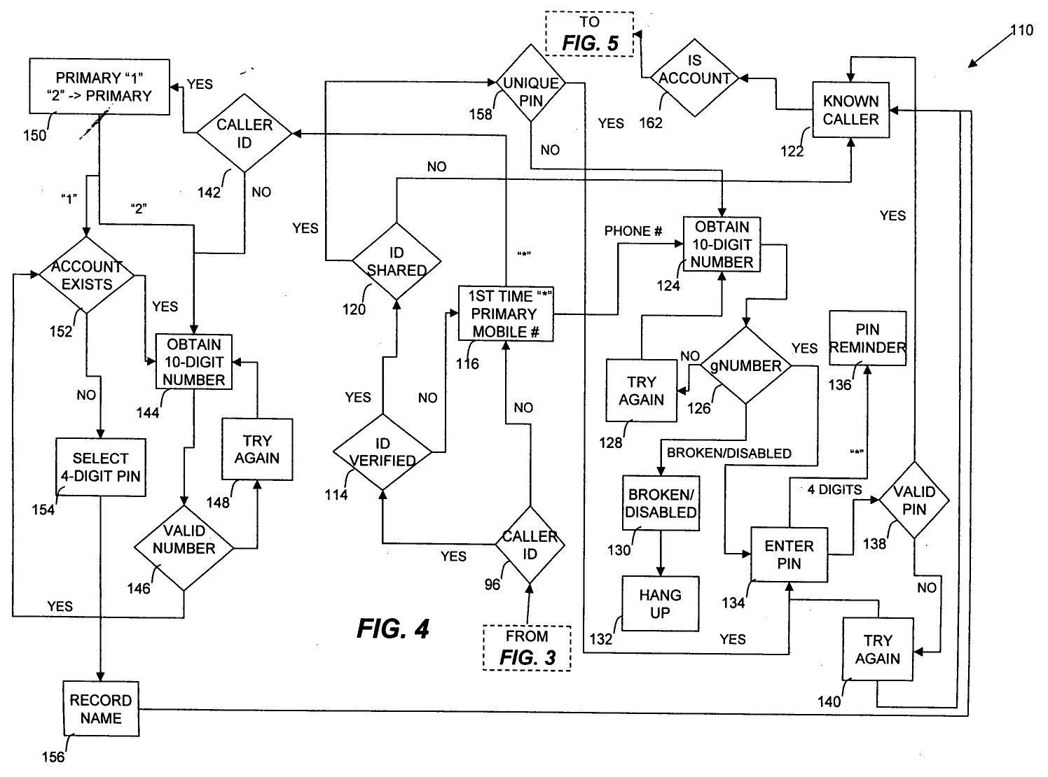

In the event that the ANI/Caller ID associates with an active subscriber 12, the call flow proceeds to active subscriber call flow diagram 110 of FIG. 4. At call flow diagram 110, after determining at query 112 that the ANI/Caller ID associates with an active global number system 30 subscriber, call flow proceeds to query 114. Query 114 determines that new call 92 associates with a global number system 30 account and that the account is verified. In the event that query 96 determines that new call 92 does not have a ANI/Caller ID, then process flow continues to step 116. At step 116, caller 36 receives a voice message similar to the following:
“IF THIS IS THE FIRST TIME YOU HAVE CALLED THIS NUMBER, PLEASE PRESS “*,” OR ENTER YOUR PRIMARY MOBILE NUMBER TO LOGIN”
   From step 116, if caller 36 pressed “*,” then call flow proceeds to step 142. If caller 36 enters the primary mobile number, then process flow continues to step 124. From query 114, if the ANI/Caller ID is associated with an active account and the account has been verified, call flow proceeds to query 120. Otherwise, call flow moves to step 116. Query 120 determines whether the ANI/Caller ID for new call 92 is shared. If so, call flow continues to query 158. If not, call flow continues to step 122. At step 122, global number system 30 has determined caller 36 to be a known caller.

If, in response to the prompt at step 116, caller 36 has entered a phone number, call flow proceeds to step 124. At step 124, global number system 30 accepts the input phone number. If, in response to the prompt at step 116, caller 36 has entered a phone number, thereby causing call flow to proceed to step 124, then global number system 30 will obtain or make use of the provided 10-digit phone number. In response to receiving a 10-digit number, global number system 30 test, at query 126 whether the provided number is that of a subscriber 12. If not, caller 36 may try again, at step 128, for up to three attempts. A failed third attempt causes global number system 30 to hang up the call in the present embodiment. Also, at query 126, global number system 30 may determine that the 10-digit number may associate with an incompletely or incorrectly registered global number 32. In such case, call flow goes to step 130, whereupon caller 36 is informed of such defect. At step 132, global number system 132 hangs up the call.

Now, if query 126 determines the 10-digit number to be associated with a valid global number 32, then call flow continues to step 134. At step 134, caller 36 is prompted to enter a four-digit PIN or to press “*” in the event caller has forgotten the PIN. If caller 36 presses “*,” then call flow goes to step 136, at which point one of any variety of secure processes for assisting caller 36 to remember the correct PIN may occur. On the other hand, in the event that caller 36 enters a PIN, then call flow goes to query 138. Query 138 test whether the provide PIN is a valid PIN for the associated global number 32. If the provided PIN is not valid, then from query 138 call flow continues to step 140. At step 140, caller 36 may attempt again to provide the proper PIN for up to three attempts. After three failed attempts to provide the correct PIN, global number system 30 will hang up the call. If query 138 determines the PIN to be a valid PIN, then global number system 30 determines caller 36 to be a known caller, i.e., a subscriber 12, thus allowing process flow to go to step 122.

In the event that caller 36 presses “*” to create an account, then call flow goes to query 142. Query 142 determines whether a ANI/Caller ID associates with new call 92. If not, call flow proceeds to step 144. At step 144, caller 36 may provide to global number system 30 a 10-digit number for use as a global number 32. After caller 36 provides a possible global number 32, call flow goes to query 146. Query 146 determines whether the provided 10-digit number may be a valid global number 32. If not, call flow goes to step 148. Step 148 provides to caller 36 the ability to try again by entering another 10-digit number for use as a new global number 32. This process may continue, in the present embodiment, for a maximum of three attempts.

From query 142, if the ANI/Caller ID associates with new call 92, then call flow proceeds to step 150. At step 150, caller 36 may receive a voice prompt such as the following:
“PRESS “1” IF THIS N R XXX-XXX-X (I.E., THE CALLER ID NUMBER) IS YOUR PRIMARY NUMBER FOR USE AS YOUR GLOBAL NUMBER. OTHERWISE, PRESS “2” TO ENTER A PRIMARY PHONE NUMBER TO USE AS YOUR GLOBAL NUMBER.”
   If caller 36 enters “1,” call flow proceeds to query 152. Query 152 determines whether an account already exists for the number caller 36 has supplied. Alternatively, if caller 36 enters “2,” then call flow goes to step 144 whereupon global number system 30 receives and processes from caller 36 a new 10-digit phone number, as described. If, at query 152, global number system 30 determines that no account presently exists with the number identified by caller 36 as the primary number, then process flow goes to step 154. Step 154 permits caller 36 to provide four-digit PIN for the new account. Then, at step 156, global number system 30 allows caller 36 to record his name. Thereafter, global number system 30 considers caller 36 to be a known caller, so call flow moves on to step 122.

Now, if at query 120, global number system 30 has determined the ANI/Caller ID to be a shared account, then call flow proceed to query 158. Query 158 test whether the PIN is unique. If not, process flow goes to step 124, whereupon global number system 30 obtains from caller 36 a 10-digit phone number. Call flow thereafter proceeds as already described above. Also, in the event that query 158 determines the PINs to be unique, call flow may proceed to step 134 whereupon caller 36 may enter the unique PIN. Thereafter, call flow may proceed as described above.

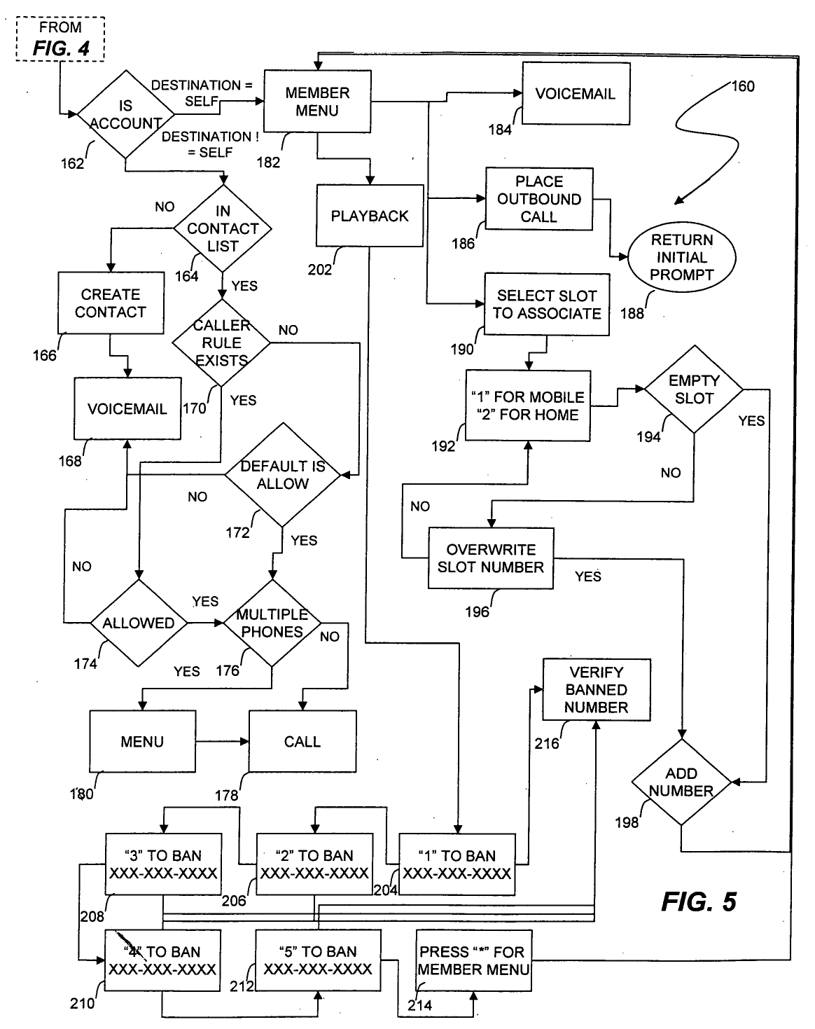

From step 122, call flow now may proceed to account call flow diagram 160 of FIG. 5, which begins, in one embodiment at query 162. Query 162 determines whether the now known caller 36 is a global number system 30 subscriber.

If query 162 determines the caller 36 not to be a global number system 30 subscriber, then call flow goes to query 164. Query 164 determines whether caller 36 is in the subscriber 12 contact list. If not, call flow continues to step 166 for creating a contact file for caller 36 in the subscriber 12 contact database. Then, call flow goes to voicemail step 168. If, on the other hnd, caller 36 has an contact file in the subscriber 12 contact database, then call flow goes to query 170. Query 170 tests whether subscriber 12 has set a call rule for caller 36. If not, call flow goes to query 172, which tests whether a default rule should apply to caller 36. If not, call flow for caller 36 continues to voicemail step 168. If, at query 170, a caller rule exists, then call flow goes to allowed query 174.

If, by way of either query 172 or 174, the caller 36 is allowed to call subscriber 12, then call flow proceeds to multiple phones query 176. Multiple phones query 176 tests whether caller 36 may call more than one phone at which subscriber 12 may be accessible. If caller 36 may not contact subscriber 12 at multiple phones, then call flow goes to call step 178 for connecting caller 36 to subscriber 12 and the specified phone. Otherwise, call flow goes to menu step 180, whereupon caller 36 may contact subscriber 12 via numerous phones. This ability to contact subscriber 12 at more than one phone may, according to subscriber 12 control, be either by way of automatically polling through such alternative numbers or selectable by caller 36. There may be other ways for allowing caller 36 to contact subscriber in various phones.

If caller 36 is a global number system 30 subscriber, then call flow continues to step 182, making available to subscriber 12 a member menu. From member menu step 182, the member may access voicemail, causing flow to go to voicemail step 184. Alternatively, subscriber 12 may place an outbound call at step 186. From outbound call step 186, call flow may proceed to initial prompt via path 188.

If subscriber 12 controls global number system 12 to go to select a slot for associating a phone number with the subscriber's 12 global number 32, then call flow proceeds to step 192. In the present embodiment, a subscriber 12 may associate up to six phone numbers with global number 32. In other embodiments, four, eight, or another number of phone numbers may be associated with global number 32. From step 192, subscriber 12 receives from global number system 30 a prompt designate as “1” or “2,” for example, to designation the slot into which the subscriber desires to designate the phone number as associated with global number 32. From step 192, call flow continues to query 194.

Query 194 determines whether the designated slot is presently available for such designation. If not, subscriber 12 receives the prompt to overwrite the present number which occupies the specific slot. If subscriber 12 performs the overwrite, then process flow goes to query 198. Otherwise, call flow returns to prompt step 192. If, on the other hand, query 194 determines the specified slot to be empty, then call flow goes to step 198. At step 198, global number system 30 receives the new number for the specified slot and directs call flow back to member menu step 182.

From member menu 182, global number system 30 permits subscriber 12 to ban a caller. Thus, if subscriber 12 chooses to ban a caller, then call flow goes to playback step 202. In the present embodiment, playback step 202 plays back the most recent five callers to subscriber 12. Banning steps 204 through 212, therefore, permit subscriber 12 to selectively ban any one of such callers. Alternatively, at step 214, subscriber 12 may return to member menu step 182.

The foregoing description of the various embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A telecommunications method comprising:
providing a global number system, said global number system providing a plurality of telecommunications functions in association with a telecommunications network, said global number system comprising at least one global number, said global number associating with said global number system for masking phone numbers associated with a plurality of telecommunications devices;
functionally associating at least one direct contact file to said at least one global number, said at least one direct contact file comprising predetermined access data for controlling access to at least one of said plurality of telecommunications devices;
receiving incoming communications from at least one outside telecommunications device to said global number through the telecommunications network for communicating with at least one of said telecommunications devices; and
controlling access to said at least one telecommunications devices from said outside telecommunications device according to said predetermined access data.

2. The method of claim 1, further comprising the step of associating said global number with said at least one of said plurality of telecommunications devices for masking a call from said at least one of said plurality of telecommunications devices as deriving from said global number.

3. The method of claim 2, further comprising the step of associating said global number system through an on-line information system for associating said at least one contact data file with said telecommunications network.

4. The method of claim 3, further comprising the step of returning said incoming communications using said on-line information system.

5. The method of claim 3, further comprising the step of placing a return call to said outside telecommunications device using one of said plurality of telecommunications devices for calling said global number system and calling said outside telecommunications device from said global number system, thereby associating said global number with said return call.

6. The method of claim 3, further comprising the steps of placing a return call to said outside telecommunications device using the steps of:
selecting said contact data file associated with said outside telecommunications device;
automatically calling said global number system, in response to said selecting step; and
automatically calling said outside telecommunications device through said global number system, in response to said selecting step.

7. A telecommunications system comprising:
a global number system, said global number system comprising instructions and circuitry for performing a plurality of telecommunications functions in association with a telecommunications network;
at least one global number associated with said global number system for masking phone numbers associated with a plurality of telecommunications devices;
associating circuitry for functionally associating at least one direct contact file to said at least one global number account, said at least one direct contact file comprising predetermined access data for controlling access to at least one of said plurality of telecommunications devices;
communications circuitry for receiving incoming communications from at least one outside telecommunications device to said global number through the telecommunications network for communicating with at least one of said telecommunications devices; and
control circuitry for controlling access to said at least one telecommunications devices from said outside telecommunications device according to said predetermined access data.

8. The telecommunications system of claim 7, further comprising instructions and circuitry for associating said global number with said at least one of said plurality of telecommunications devices for masking a call from said at least one of said plurality of telecommunications devices as deriving from said global number.

9. The telecommunications system of claim 8, further comprising instructions and circuitry for associating said global number system through an on-line information system for associating said at least one contact data file with said telecommunications network.

10. The telecommunications system of claim 9, further comprising instructions and circuitry for returning said incoming communications using said on-line information system.

11. The telecommunications system of claim 9, further comprising instructions and circuitry for placing a return call to said outside telecommunications device using one of said plurality of telecommunications devices for calling said global number system and calling said outside telecommunications device from said global number system, thereby associating said global number with said return call.

12. The telecommunications system of claim 9, further comprising instructions and circuitry for placing a return call to said outside telecommunications device using instructions and circuitry comprising:
selection circuitry for selecting said contact data file associated with said outside telecommunications device;
automatic global number system calling instructions and circuitry for automatically calling said global number system, in response to said selecting step; and
automatic calling instructions and circuitry for automatically calling said outside telecommunications device through said global number system, in response to said selecting step.

13. A global number system, comprising:
means for providing a plurality of telecommunications functions in association with a telecommunications network, said global number system comprising at least one global number, said global number associating with said global number system for masking phone numbers associated with a plurality of telecommunications devices;
means for functionally associating at least one direct contact file to said at least one global number account, said at least one direct contact file comprising predetermined access data for controlling access to at least one of said plurality of telecommunications devices;
means for receiving incoming communications from at least one outside telecommunications device to said global number through the telecommunications network for communicating with at least one of said telecommunications devices; and
means for controlling access to said at least one telecommunications devices from said outside telecommunications device according to said predetermined access data.

14. The global number system of claim 13, further comprising means for associating said global number with said at least one of said plurality of telecommunications devices for masking a call from said at least one of said plurality of telecommunications devices as deriving from said global number.

15. The global number system of claim 14, further comprising means for associating said global number system through an on-line information system for associating said at least one contact data file with said telecommunications network.

16. The global number system of claim 15, further comprising means for returning said incoming communications using said on-line information system.

17. The global number system of claim 15, further comprising means for placing a return call to said outside telecommunications device using one of said plurality of telecommunications devices for calling said global number system and calling said outside telecommunications device from said global number system, thereby associating said global number with said return call.

18. The global number system of claim 15, further comprising:
means for placing a return call to said outside telecommunications device using
means for selecting said contact data file associated with said outside telecommunications device;
means for automatically calling said global number system, in response to said selecting step; and
means for automatically calling said outside telecommunications device through said global number system, in response to said selecting step.

19. A computer usable medium having computer readable program code means embodied therein for providing secure telecommunications services including a single global phone number, the computer usable medium comprising:
computer readable program code means for providing a plurality of telecommunications functions in association with a telecommunications network, said telecommunications functions comprising providing a global number system comprising at least one global number, said global number associating with said global number system for masking phone numbers associated with a plurality of telecommunications devices;
computer readable program code means for functionally associating at least one direct contact file to said at least one global number account, said at least one direct contact file comprising predetermined access data for controlling access to at least one of said plurality of telecommunications devices;
computer readable program code means for receiving incoming communications from at least one outside telecommunications device to said global number through the telecommunications network for communicating with at least one of said telecommunications devices; and
computer readable program code means for controlling access to said at least one telecommunications devices from said outside telecommunications device according to said predetermined access data.

20. The computer usable medium of claim 19, further comprising computer readable program code means for associating said global number with said at least one of said plurality of telecommunications devices for masking a call from said at least one of said plurality of telecommunications devices as deriving from said global number.
